(19) United States
(12) Patent Application Publication
(10) Pub. No.: US 2012/0314981 A1
(43) Pub. Date: Dec. 13, 2012

(54) HYDRODYNAMIC BEARING ASSEMBLY AND METHOD OF MANUFACTURING THE SAME

(75) Inventor: Sang Hyun KWON, Suwon (KR)

(73) Assignee: Samsung Electro-Mechanics Co., Ltd.

(21) Appl. No.: 13/491,228

(22) Filed: Jun. 7, 2012

(30) Foreign Application Priority Data
Jun. 8, 2011 (KR) 10-2011-0054961

(51) Int. Cl. F16C 32/06; B23P 17/02

(52) U.S. Cl. 384/121; 384/100; 29/898.11

(57) ABSTRACT

There are provided a hydrodynamic bearing assembly and a method of manufacturing the same. The hydrodynamic bearing assembly includes: an oil sealing part formed between a fixed member and a rotating member; and an oil barrier film disposed so as to prevent leakage of oil from the oil sealing part and including a self-assembled monolayer formed on a surface of at least one of the fixed member and the rotating member. The oil barrier film may be easily formed at room temperature and be continuously used for a long period of time without being damaged due to external impacts.

### CROSS-REFERENCE TO RELATED APPLICATIONS

This application claims the priority of Korean Patent Application No. 10-2011-0054961 filed on Jun. 8, 2011, in the Korean Intellectual Property Office, the disclosure of which is incorporated herein by reference.

### BACKGROUND OF THE INVENTION

1. Field of the Invention

The present invention relates to a hydrodynamic bearing assembly for significantly reducing lubricating fluid scattering.

2. Description of the Related Art

A hard disk drive (HDD), an information storage device, reads data stored on a disk or writes data to a disk using a read/write head.

The hard disk drive requires a disk drive device capable of driving the disk. In the disk drive device, a small-sized spindle motor is used.

This small-sized spindle motor has used a hydrodynamic bearing assembly. A shaft, a rotating member of the hydrodynamic bearing assembly, and a sleeve, a fixed member thereof have a lubricating fluid interposed therebetween, such that the shaft is supported by fluid dynamic pressure generated in the lubricating fluid.

Further, in the spindle motor including the hydrodynamic bearing assembly, a sealing part is configured using fluid surface tension and a capillary phenomenon. In the sealing part, stability is one of a range of important factors.

However, when an external impact is applied to the spindle motor in a state in which the spindle motor is driven and stopped, the lubricating fluid forming a fluid-air interface is leaked to the outside, whereby a loss of the lubricating fluid may deteriorate driving stability of the spindle motor.

Therefore, research into a technology of preventing the leakage of lubricating fluid when an external impact is applied to a spindle motor and allowing the lubricating fluid to be re-introduced to a fluid-air interface, even in the case that the lubricating fluid is leaked, thereby improving stability of motor driving, has been urgently demanded.

### SUMMARY OF THE INVENTION

An aspect of the present invention provides a hydrodynamic bearing assembly for significantly reducing lubricating fluid scattering.

According to an aspect of the present invention, there is provided a hydrodynamic bearing assembly including: an oil sealing part formed between a fixed member and a rotating member; and an oil barrier film disposed so as to prevent leakage of oil from the oil sealing part and including a self-assembled monolayer formed on a surface of at least one of the fixed member and the rotating member.

The oil barrier film may be formed at room temperature.

The oil barrier film may be formed of a solution containing at least one selected from the group consisting of CF₃(CH₂)ₙ—Si—Cl₃, CH₃(CH₂)ₙ—Si—Cl₃, CF₃(CH₂)ₙ—S—H, and CH₃(CH₂)ₙ—S—H.

The oil barrier film may have hydrophobicity, and the oil barrier film may be chemically bonded to the surface of at least one of the fixed member and the rotating member.

The oil barrier film may include at least one of CF₃ and CH₃ terminal functional groups.

The fixed member may include a sleeve and a cap, and the rotating member may include a shaft, a thrust plate, and a hub.

According to another aspect of the present invention, there is provided a method of manufacturing a hydrodynamic bearing assembly, the method including: preparing a fixed member and a rotating member having an oil sealing part formed therebetween; and forming an oil barrier film disposed so as to prevent leakage of oil from the oil sealing part and including a self-assembled monolayer formed on a surface of at least one of the fixed member and the rotating member.

The forming of the oil barrier film may be performed at room temperature.

The oil barrier film may have hydrophobicity, and may be chemically bonded to the surface of at least one of the fixed member and the rotating member.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic cross-sectional view showing a motor including a hydrodynamic bearing assembly according to an embodiment of the present invention;

FIGS. 2 and 3 are enlarged views showing another example of part A of FIG. 1;

FIG. 4 is a microscope photograph showing an oil contact angle before and after an oil barrier film is formed according to the embodiment of the present invention; and

FIG. 5 is an enlarged view showing a self-assembled monolayer included in the oil barrier film according to the embodiment of the present invention.

### DETAILED DESCRIPTION OF THE EMBODIMENTS

Embodiments of the present invention may be modified in many different forms and the scope of the invention should not be construed as being limited to the embodiments set forth herein. Rather, these embodiments are provided so that this disclosure will be thorough and complete, and will fully convey the concept of the invention to those skilled in the art. In the drawings, the shapes and dimensions of components may be exaggerated for clarity, and the same reference numerals will be used throughout to designate the same or like components.

Embodiments of the present invention will now be described in detail with reference to the accompanying drawings.

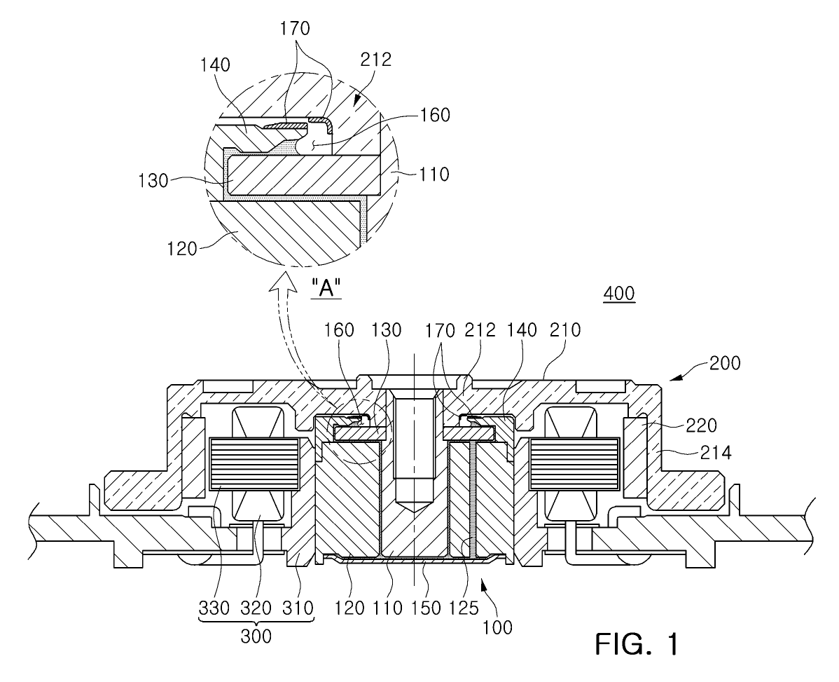

FIG. 1 is a schematic cross-sectional view showing a motor including a hydrodynamic bearing assembly according to an embodiment of the present invention.

Referring to FIG. 1, a hydrodynamic bearing assembly 100 according to an embodiment of the present invention may include an oil sealing part 160 formed between a fixed member 120 or 140 and a rotating member 110, 130, or 212; and an oil barrier film 170 disposed so as to prevent leakage of oil from the oil sealing part 160 and including a self-assembled monolayer formed on a surface of at least one of the fixed member and the rotating member.

Hereinafter, the above configuration will be described in detail.

The fixed member may include a sleeve 120 and a cap 140, and the rotating member may include a shaft 110, a thrust plate 130, and a hub 212.

The oil sealing part 160 may be formed between the fixed member 120 or 140 and the rotating member 110, 130, or 212, particularly, between the sleeve 120, the thrust plate 130, and the cap 140.

The cap 140 may be press-fitted to an upper portion of the thrust plate 130 to seal a lubricating fluid between the cap 140 and the thrust plate 130, and include a circumferential groove formed in an outer diameter direction so that the cap 140 may be press-fitted to the thrust plate 130 and the sleeve 120.

The cap 140 may include a protrusion part formed on a lower surface thereof in order to seal the lubricating fluid, which uses a capillary phenomenon and a lubricating fluid surface tension in order to prevent the lubricating fluid from being leaked to the outside at the time of driving of the motor.

The hydrodynamic bearing assembly 100 according to the embodiment of the present invention may include the oil barrier film 170 disposed so as to prevent the leakage of the oil from the oil sealing part 160 and including the self-assembled monolayer formed on the surface of at least one of the fixed member and the rotating member.

The oil barrier film 170 is not particularly limited, but may be formed on a surface of the fixed member, particularly, the cap 140, a surface of the rotating member, particularly, the hub 212, or surfaces of both of the fixed member and the rotating member.

Referring to FIG. 1, the hydrodynamic bearing assembly 100 according to the embodiment of the present invention may include the oil barrier film 170 formed on the surfaces of the cap 140 and the hub 212.

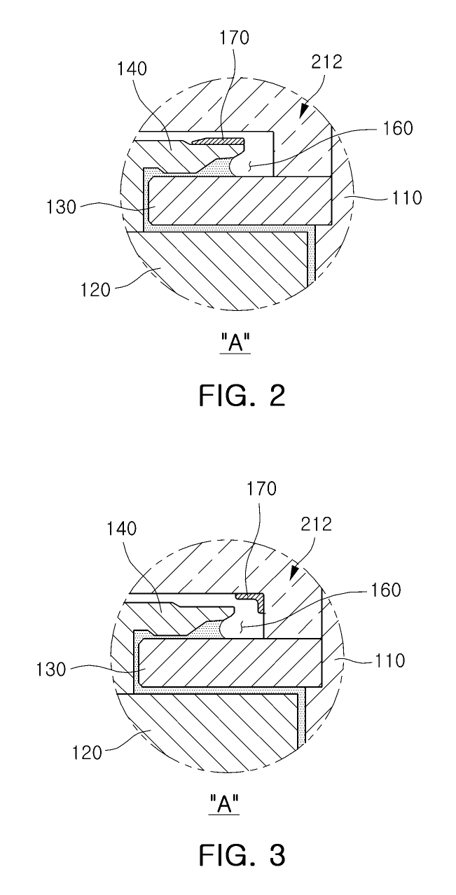

Referring to FIGS. 2 and 3, the hydrodynamic bearing assembly 100 according to another embodiment of the present invention may include the oil barrier film 170 formed on the surface of the cap 140 or the surface of the hub 212.

The oil barrier film 170 may be formed at room temperature.

According to the related art, an oil repellant agent coating containing a fluorinated polymer having a fluoro (F) alkyl group as a main component needs to be formed in order to suppress scattering of the lubricating fluid. Therefore, a heating drying process at a temperature of 80° C. to 200° C. and a UV irradiating processing are required, such that a process yield is low.

However, according to the embodiment of the present invention, since the oil barrier film 170 for significantly reducing the scattering of the lubricating fluid may be formed at room temperature, an additional process is not required, such that a process is simplified and a process yield is high.

In addition, the oil barrier film 170 may be formed of a solution containing at least one selected from a group consisting of, for example, CF₃(CH₂)ₙ—Si—Cl₃, CH₃(CH₂)ₙ—Si—Cl₃, CF₃(CH₂)ₙ—S—H, and CH₃(CH₂)ₙ—S—H, but is not particularly limited.

More specifically, the oil barrier film 170 may be formed of a solution prepared using at least one solute selected from a group consisting of, for example, CF₃(CH₂)ₙ—Si—Cl₃, CH₃(CH₂)ₙ—Si—Cl₃, CF₃(CH₂)ₙ—S—H, and CH₃(CH₂)ₙ—S—H and a solvent such as hexane, ethylalcohol, or the like.

That is, the oil barrier film may be a hydrophobic film simply formed by applying the solution to the surface of at least one of the fixed member and the rotating member and then drying the solution at room temperature.

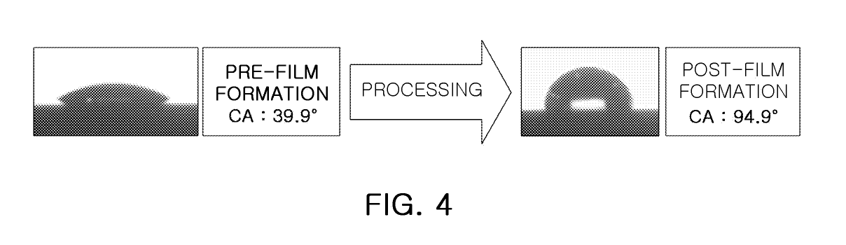

FIG. 4 is a microscope photograph showing an oil contact angle before and after an oil barrier film is formed according to the embodiment of the present invention.

Referring to FIG. 4, an angle at which oil contacts a solid surface before the oil barrier film is formed is 39.9 degrees, which indicates lipophilicity; however, an angle at which the oil contacts the oil barrier film after the oil barrier film is formed is 94.9 degrees, which indicates hydrophobicity.

Generally, a case in which a contact angle between a solid surface and oil is below 90 degrees indicates lipophilicity, while a case in which a contact angle between a solid surface and oil is above 90 degrees indicates hydrophobicity. Therefore, according to the embodiment of the present invention, the contact angle between the solid surface and the oil before the oil barrier film is formed is smaller than 90 degrees, which indicates lipophilicity; however, the contact angle between the solid surface and the oil after the oil barrier film is formed is above 90 degrees, which indicates hydrophobicity.

In addition, since the oil barrier film is formed at room temperature, a hydrophobic film may be easily formed in a simple process.

Meanwhile, the oil barrier film may have hydrophobicity and be chemically bonded to the surface of at least one of the fixed member and the rotating member.

The oil barrier film includes at least one of CF₃ and CH₃ terminal functional groups, such that it may have hydrophobicity as described above.

In addition, the oil barrier film 170 may be chemically bonded to the surface of at least one of the fixed member and the rotating member. This chemical bonding may be made by chemical bonding between the surface and a SiO₃ or SiCl₃ functional group included in the oil barrier film.

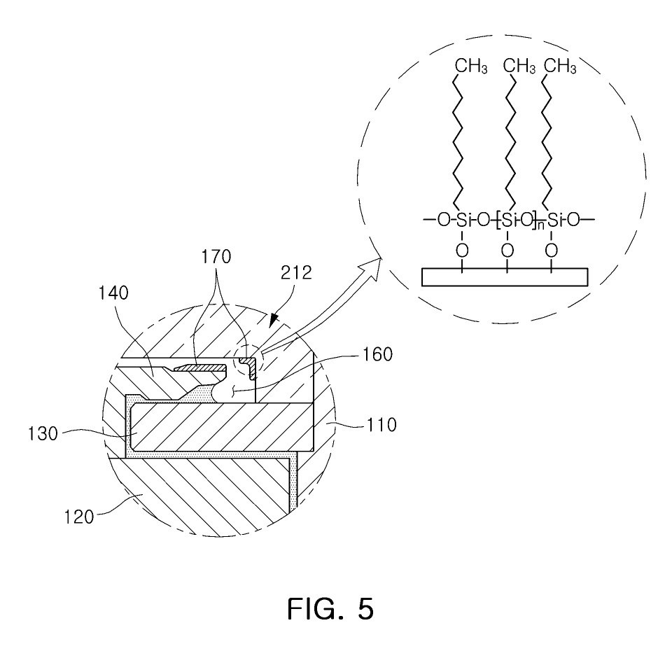

FIG. 5 is an enlarged view showing a self-assembled monolayer included in the oil barrier film according to the embodiment of the present invention.

The oil barrier film may include the self-assembled monolayer (SAM).

The self-assembled monolayer may be defined as an organic monolayer spontaneously formed on a solid surface.

In this case, a structure of the self-assembled monolayer may be mainly divided into three portions. A first portion, a head group, may be a portion chemically adsorbed on the surface.

According to the embodiment of the present invention, the head group in the structure of the self-assembled monolayer may be the SiO₃ or SiCl₃ functional group and may be chemically coupled to the surface of at least one of the fixed member and the rotating member.

In a second portion, an alkyl chain, an arranged monolayer, may be formed due to Van der Walls interaction between long chains.

A third portion is a terminal functional group portion. According to the embodiment of the present invention, the oil barrier film may include a terminal functional group so as to have hydrophobicity.

The terminal functional group is not particularly limited as long as it may have hydrophobicity. For example, the terminal functional group may be at least one of CF₃ and CH₃ terminal function groups.

The case in which the oil barrier film according to the embodiment of the present invention includes CH₃ formed as the terminal functional group is shown in FIG. 5.

According to the embodiment of the present invention, since the oil barrier film 170 is chemically bonded to the surface of at least one of the fixed member and the rotating member as described above, the oil barrier film 170 may suppress the scattering of the lubricating fluid and be continuously used without being damaged due to external impacts.

That is, the oil barrier film 170 is chemically coupled to the above-mentioned members, such that it may have improved impact resistance and be continuously used. In addition, the oil barrier film 170 has hydrophobicity due to the terminal group included therein, such that the scattering of the lubricating fluid may be suppressed.

Further, since the oil barrier film 170 may be formed at room temperature, the improvement of a process yield as well as the suppression of lubricating fluid scattering and the improvement of impact resistance and durability may be accomplished.

Meanwhile, the hydrodynamic bearing assembly 100 according to the embodiment of the present invention may include the shaft 110, the sleeve 120, the thrust plate 130, the cap 140, and the oil sealing part 160.

The sleeve 120 may support the shaft 110 while allowing an upper end of the shaft 110 to be protruded in an upward axial direction, and may be formed by forging Cu or Al or sintering a Cu—Fe based alloy powder or an SUS based powder.

Here, the shaft 110 may be inserted into a shaft hole of the sleeve 120 so as to have a micro clearance therewith, wherein the micro clearance is filled with the lubricating fluid. The rotation of a rotor 200 may be more smoothly supported by a radial dynamic pressure groove formed in at least one of an outer diameter portion of the shaft 110 and an inner diameter portion of the sleeve 120.

The radial dynamic pressure groove may be formed in an inner surface of the sleeve 120, an inner portion of the shaft hole of the sleeve 120, and generate pressure so as to be biased toward one side at the time of rotation of the shaft 110.

However, the radial dynamic pressure grooves are not limited to being formed in the inner surface of the sleeve 120 as described above, but may also be formed in the outer diameter portion of the shaft 110. In addition, the number of radial dynamic pressure grooves is not limited.

The sleeve 120 may include a bypass channel 125 formed therein in order to allow upper and lower portions thereof to communicate with each other to disperse pressure of the lubricating fluid in an inner portion of a hydrodynamic bearing assembly 100, thereby maintaining uniformity in the pressure, and may move air bubbles, or the like, present in the inner portion of the hydrodynamic bearing assembly 100 so as to be discharged by circulation.

Here, the sleeve 120 may include a cover plate 150 coupled thereto at a lower portion thereof, having a clearance therewith, wherein the clearance receives the lubricating fluid therein.

The cover plate 150 may receive the lubricating fluid in the clearance between the cover plate 150 and the sleeve 120 to serve as a bearing supporting a lower surface of the shaft 110.

The thrust plate 130 may be disposed on an upper portion of the sleeve 120 in an axial direction and include a hole formed at the center thereof, the hole corresponding to a cross section of the shaft 110. The shaft 110 may be inserted into this hole.

Here, the thrust plate 130 may be separately fabricated and then coupled to the shaft 110. However, the thrust plate 130 may be formed integrally with the shaft 110 at the time of fabricating thereof and may rotate together with the shaft 110 at the time of the rotation of the shaft 110.

In addition, the thrust plate 130 may include a thrust dynamic pressure groove formed in an upper surface thereof, and the thrust dynamic pressure groove provides thrust dynamic pressure to the shaft 110.

The thrust dynamic pressure groove is not limited to being formed in the upper surface of the thrust plate 130 as described above, but may also be formed in an upper surface of the sleeve 120 corresponding to a lower surface of the thrust plate 130.

The stator 300 may include a coil 320, a core 330, and a base member 310.

In other words, the stator 300 may be a fixed structure including the coil 320 generating electromagnetic force having a predetermined magnitude when power is applied thereto, and the plurality of cores 330 having the coil 320 wound therearound.

The core 330 may be fixedly disposed on an upper portion of the base member 310 on which a printed circuit board (not shown) having pattern circuits printed thereon is provided. A plurality of coil holes having a predetermined size may be formed in an upper surface of the base member 310 corresponding to the winding coil 320 so as to penetrate through the base member 120 in order to expose the winding coil 320 downwardly, and the winding coil 320 may be electrically connected to the printed circuit board (not shown) in order to supply external power.

An outer peripheral surface of the sleeve 120 may be press-fitted into the base member 310 to thereby be fixed thereto, and the core 330 having the coil 320 wound therearound may be inserted into the base member 310. In addition, the base member 310 and the sleeve 120 may be connected to each other by applying an adhesive to an inner surface of the base member 310 or an outer surface of the sleeve 120.

The rotor 200, a rotating structure rotatably provided with respect to the stator 300, may include a rotor case 210 having an annular ring shaped magnet 220 provided on an inner peripheral surface thereof, wherein the annular ring shaped magnet 220 corresponds to the core 330, having a predetermined interval therebetween.

In addition, the magnet 220 may be a permanent magnet generating magnetic force having a predetermined strength by alternately magnetizing an N pole and an S pole thereof in a circumferential direction.

Here, the rotor case 210 may include a hub base 212 press-fitted into and fixed to the upper end of the shaft 110 and a magnet support part 214 extended from the hub base 212 in an outer diameter direction and bent in a downward axial direction to support the magnet 220.

Meanwhile, a method of manufacturing the hydrodynamic bearing assembly 100 according to another embodiment of the present invention may include preparing a fixed member and a rotating member having an oil sealing part formed therebetween; and forming an oil barrier film disposed so as to prevent leakage of oil from the oil sealing part and including a self-assembled monolayer formed on a surface of at least one of the fixed member and the rotating member.

The method of manufacturing a hydrodynamic bearing assembly 100 according to another embodiment of the present invention may be in accordance with a general method of manufacturing a hydrodynamic bearing assembly, except for a specific feature of the present invention.

Hereinafter, a feature of the method of manufacturing a hydrodynamic bearing assembly 100 according to another embodiment of the present invention will be described in detail. However, descriptions overlapped with the above-described feature of the hydrodynamic bearing assembly and a general manufacturing process will be omitted.

In the method of manufacturing the hydrodynamic bearing assembly 100, according to the embodiment of the present invention, a fixed member and a rotating member having an oil sealing part formed therebetween may first be prepared.

The fixed member and the rotating member are not particularly limited. Examples of the fixed member and the rotating member have been described above.

Next, an oil barrier film, disposed so as to prevent the leakage of oil from the oil sealing part and including a self-assembled monolayer formed on a surface of at least one of the fixed member and the rotating member, may be formed.

The forming of the oil barrier film may be performed at room temperature. Therefore, a heating or UV curing process is not required, and a processing time may be reduced, thereby improving a process yield.

In addition, the oil barrier film may have hydrophobicity and be chemically bonded to the surface of at least one of the fixed member and the rotating member.

That is, the oil barrier film has hydrophobicity, such that the scattering of the lubricating fluid may be significantly reduced. In addition, the oil barrier film is chemically bonded as described above, such that the oil barrier film may have improved impact resistance and be continuously used for a long period of time.

As set forth above, in a hydrodynamic bearing assembly according to embodiments of the present invention, since an oil barrier film may be simply formed at room temperature, the oil barrier film may be easily formed as compared to the oil barrier film according to the related art.

In addition, the oil barrier film is chemically bonded to a surface of at least one of a fixed member and a rotating member to significantly reduce lubricating fluidscattering, whereby the oil barrier film may be continuously used for a long period of time without being damaged due to external impacts.

While the present invention has been shown and described in connection with the embodiments, it will be apparent to those skilled in the art that modifications and variations can be made without departing from the spirit and scope of the invention as defined by the appended claims.

What is claimed is:

1. A hydrodynamic bearing assembly comprising:
an oil sealing part formed between a fixed member and a rotating member; and
an oil barrier film disposed so as to prevent leakage of oil from the oil sealing part and including a self-assembled monolayer formed on a surface of at least one of the fixed member and the rotating member.

2. The hydrodynamic bearing assembly of claim 1, wherein the oil barrier film is formed at room temperature.

3. The hydrodynamic bearing assembly of claim 1, wherein the oil barrier film is formed of a solution containing at least one selected from the group consisting of CF₃(CH₂)ₙ—Si—Cl₃, CH₃(CH₂)ₙ—Si—Cl₃, CF₃(CH₂)ₙ—S—H, and CH₃(CH₂)ₙ—S—H.

4. The hydrodynamic bearing assembly of claim 1, wherein the oil barrier film has hydrophobicity.

5. The hydrodynamic bearing assembly of claim 1, wherein the oil barrier film is chemically bonded to the surface of at least one of the fixed member and the rotating member.

6. The hydrodynamic bearing assembly of claim 1, wherein the oil barrier film includes at least one of CF₃ and CH₃ terminal functional groups.

7. The hydrodynamic bearing assembly of claim 1, wherein the fixed member includes a sleeve and a cap.

8. The hydrodynamic bearing assembly of claim 1, wherein the rotating member includes a shaft, a thrust plate, and a hub.

9. A method of manufacturing a hydrodynamic bearing assembly, the method comprising:
preparing a fixed member and a rotating member having an oil sealing part formed therebetween; and
forming an oil barrier film disposed so as to prevent leakage of oil from the oil sealing part and including a self-assembled monolayer formed on a surface of at least one of the fixed member and the rotating member.

10. The method of claim 9, wherein the forming of the oil barrier film is performed at room temperature.

11. The method of claim 9, wherein the oil barrier film has hydrophobicity.

12. The method of claim 9, wherein the oil barrier film is chemically bonded to the surface of at least one of the fixed member and the rotating member.
